(19) United States
(12) Patent Application Publication
(10) Pub. No.: US 2012/0159837 A1
(43) Pub. Date: Jun. 28, 2012

(54) COMPRESSED GAS INSECTICIDE DUST APPLICATOR

(76) Inventors: Glen M. Arnott, New Braunfels, TX (US); William P. Arnott, Houston, TX (US)

(21) Appl. No.: 13/216,929

(22) Filed: Aug. 24, 2011

Related U.S. Application Data
(60) Provisional application No. 61/425,871, filed on Dec. 22, 2010.

(51) Int. Cl. A01M 9/00

(52) U.S. Cl. 43/132.1

(57) ABSTRACT

Applicants provide an application for a dust insecticide for pest control in residential, commercial or other properties. The applicator consists of an assembly, including a dust container and a compressed gas cylinder. The compressed gas cylinder is connected by a high pressure hose to a blowgun that has a barrel attached to it. At the end of the barrel is a nozzle. The nozzle receives dust through an elongated tube from a dust container. A venturi in a nozzle with a small opening proximate to the venturi creates a vacuum when compressed air is forced through it and sucks in dust from the dust container. The insecticide dust mixes with the compressed gas and is fired out of an outlet tube connected to the nozzle. The stream of high pressure compressed gas with an insecticide mixed to be directed at areas around building structures where pests may be found.

This application claims the benefit of U.S. Provisional Application Ser. No. 61/425,871, filed Dec. 22, 2010.

### FIELD OF THE INVENTION

Insecticide applicators, more specifically, a compressed gas insecticide dust applicator.

### BACKGROUND OF THE INVENTION

Insecticide dust is applied through weep holes in exterior masonry work, crawl spaces, in attics and soffits, and in other places. Presently, the method of application to small holes, cracks, and the like requires the use of a handheld compressible bulb containing insecticide dust (see FIG. 4). When the bulb is compressed, the insecticide dust is dispensed through an elongated tube attached to the bulb. For larger areas, treatment with an electric motor driven commercial duster is used. Commercial dusters are generally referred to as box blowers and operate similar to a vacuum and sweeper in reverse, and blow dust air mixture out through a one inch diameter tube.

### SUMMARY OF THE INVENTION

Applicants' invention relates to an apparatus for application of a dust insecticide for pest control in residential, commercial, and other properties and structures. Applicants provide an applicator that consists of an assembly including a dust container and a compressed gas cylinder. The compressed gas cylinder is connected by a high pressure air hose to a blowgun, and compressed high pressure gas, such as CO₂ is provided to a nozzle at the removed end of the blowgun. The nozzle receives dust through an elongated tube or line from the dust container. The nozzle is affixed to a wand consisting of two rigid tubes, a vacuum/dust tube and a pressurized gas supply tube.

A trigger or handheld valve is located on the blowgun portion of the wand. This trigger has a momentary on/off valve for actuating the nozzle and allowing high pressure gas to move through the venturi of the nozzle of the wand.

### BRIEF DESCRIPTION OF THE DRAWINGS

FIG. 1 is a side elevational view illustrating the components of Applicants' device.

FIG. 2A is a detail side elevational cutaway view of a portion of the nozzle of an embodiment of Applicants' device.

FIG. 2B is an exploded detail view of a portion of FIG. 2A.

FIGS. 3A and 3B are side perspective views of an embodiment of Applicants' device used to treat soffits (FIG. 3A) and weep holes (in the next FIG. 4).

FIG. 4 is an illustration of a prior art bulb-type insecticide dust applicator.

### DETAILED DESCRIPTION OF THE PREFERRED EMBODIMENT

The figures illustrate various views, components, and the structure of Applicants' compressed gas insecticide dust applicator (hereinafter “applicator 10”). Applicator 10 is seen to be comprised of a number of sub-elements. A wand 11 is connected by a pair of hoses to a high pressure compressed gas cylinder 12 and an insecticide dust container 14. Cylinder 12 and container 14 are typically joined together by use of straps 20, with the dust container 14 being inverted with respect to the upright gas cylinder 12. A shoulder harness or a backpack unit 21 may be provided so that the user may wear the assembly comprising cylinder 12 and container 14 on his or her back.

Cylinder 12 contains high pressure compressed gas, such as compressed CO₂ gas, for example, about 870-2000 psi. Dust container 14 is at ambient temperature and pressure and contains a powder, such as Delta Dust®, which is an insecticide dust. Any appropriate insecticide dust may be used with Applicants' device. Container 14 also contains a vented cap 18 at a removed end thereof and a fitting 22a to receive, by gravitational feed, the dust and to feed the dust as set forth further herein, into feed tube 22. Cap 18 may be removed to add insecticide dust to the container.

Turning back to compressed gas cylinder 12, it is seen to have an on/off valve 15 as is known in the art to control the release of gas from the cylinder. Downstream of on/off valve 15 is a regulator 16, which may be a set pressure regulator or an adjustable regulator, and may be set, for example, between about 50 psi and 250 psi. One such regulator is available from Rehvac, Model 251C. Pressure regulator 16 may include gauges for display of tank and regulated pressure and safety release vents as known in the art of regulators. At the downstream outlet thereof, regulator has a fitting 13a for engaging the near end of gas pressure hose 13. Gas pressure hose 13 carries compressed gas to a fitting 13b at the removed end thereof for engagement to either a quick coupler 26 or for engagement directly to a blowgun 24. Blowgun 24 is typical of blowguns known in the art, such as those available from Nycoil®. Gas pressure hose 13 may be a flexible six foot by 3/16 inch hose, such as those available from Rehvac, San Antonio, Tex., and fitting 13b at the removed end thereof may fit to the quick coupler 26 or directly to the upstream end of blowgun 24. Blowgun 24 includes an on/off valve or trigger 24a for manually controllably releasing the high pressure gas upstream thereof to a barrel 28 of wand assembly 11. Wand assembly 11 is comprised of a blowgun 24, the optional quick coupler 26, barrel 28a, nozzle 32, and an outlet tube 34.

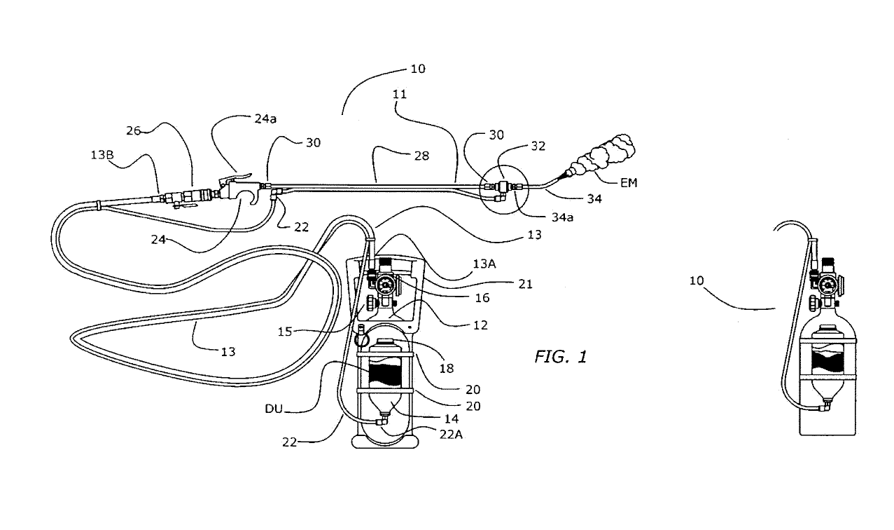

Both feed tube 22 and regulated high pressure hose 13 are flexible and may be between about 4 feet long to about 10 feet long or any suitable length, and may be about ¼″ outer diameter or any suitable diameter. The barrel 28 is typically rigid, and outlet tube 34 may be rigid, semi-rigid or flexible. Barrel 28 is seen to comprise of a pair of tubes, such as rigid, ¼ inch copper tubes, the pair comprising a first tube 28a and a second tube 28b. First tube 28a engages an outlet or downstream end of blowgun 24 and carries compressed gas to a fitting 30 for engagement to nozzle 32. Barrel tube 28b receives insecticide dust from feed tube 22 and may include an L-shaped or 90° fitting as seen in FIG. 1 to engage feed tube 22 to barrel tube 28b. Removed end of barrel tube 28b is seen to be engaged, typically again through a 90° fitting to nozzle 32. In an alternate embodiment, feed tube 22 may directly engage nozzle 32 and the barrel would have only a single rigid tube.

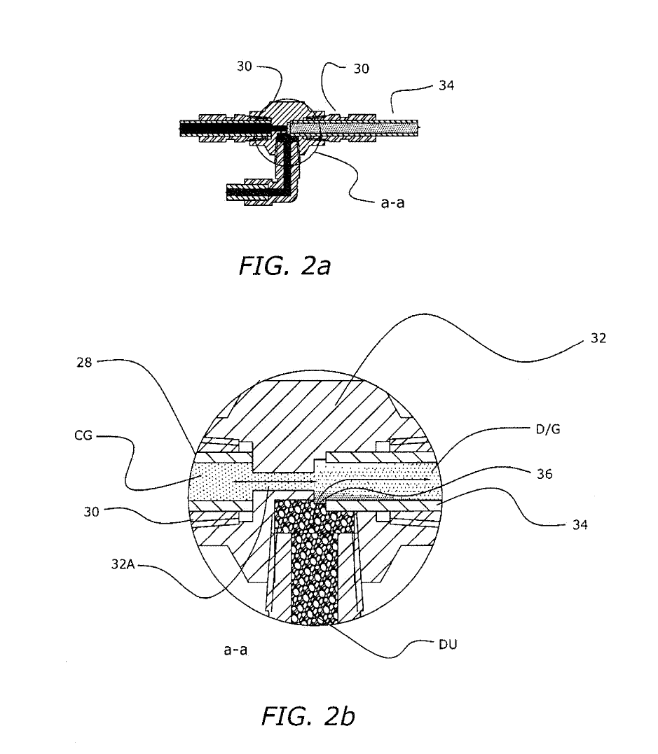

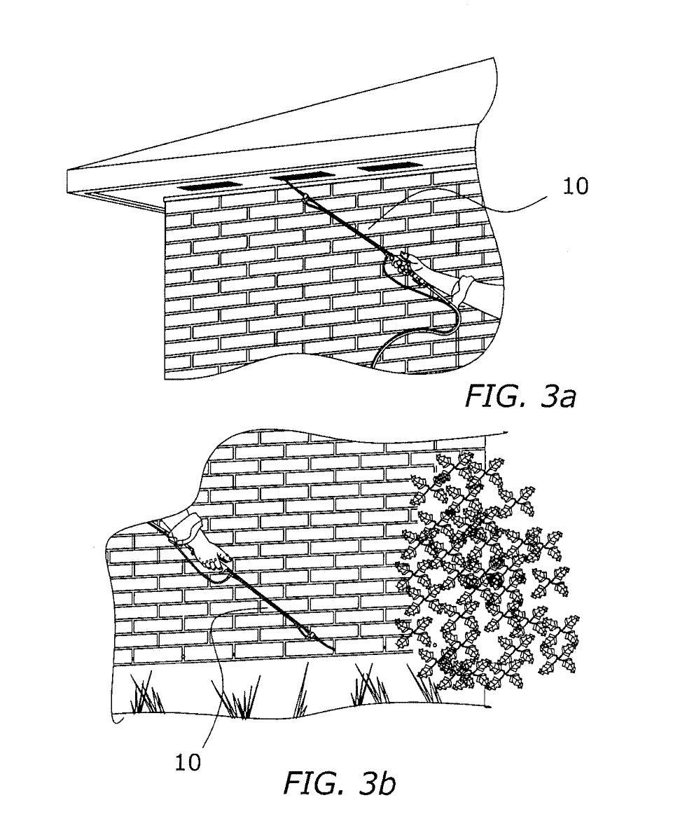

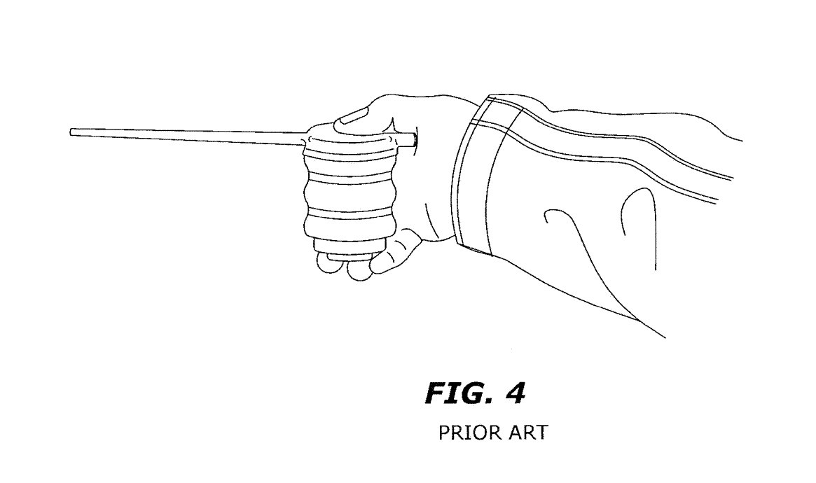

Turning now to details of nozzle 32, as best seen in FIGS. 2A and 2B, it is seen that nozzle 32 is adapted to receive a high pressure regulated gas supply from gas cylinder 12 and it is adapted also to receive a dust supply from container 14 and to further combine the high pressure gas with the dust and to expel it from a third opening.

Nozzle 32 is adapted to receive compressed gas and squeeze it down through a narrow constriction or venturi 32a, which venturi then opens into a larger channel, which ends in expelling a mixture of dust and gas D/G, typically as an emulsion, through the removed end of outlet tube 34. Outlet tube 34 is typically approximately five inches long from where it engages the nozzle 32 typically at a fitting 34a to the removed end thereof and has an inner channel of diameter about 0.200″ to about 0.250″. The nozzle provides for first the squeezing and acceleration of a gas through venturi 32a, then an expansion and slowing of the gas as it leaves the venturi.

The venturi effect is the reduction in gas pressure that results from the fluid as it flows through the constricted section or venturi 32a of a constrained channel, tube fitting or pipe. A gas or fluid's velocity must increase as it passes through the constriction to satisfy the Conservation of Mass and the pressure must decrease to satisfy the Conservation of Energy. The venturi effect is derived from Bernoulli's principle.

Applicants' venturi is used to provide a mixture of the gas and the dust to form an emulsion. Applicants provide a gap or opening 36, such as an 0.08 inch gap in or adjacent the venturi, which opening is located at a low pressure or at least partial vacuum, typically lower than ambient pressure, and which opening is in fluid or gaseous communication with dust DU of dust container 14. That is to say, opening 36 utilizes a pressure differential between the ambient air pressure in the dust container 14 and the lower pressure or vacuum at or near opening 36 to provide for gaseous movement, which gaseous movement carries dust DU therewith from the container, which is vented typically through vented cap 18 through feed tube 22 to barrel 28b and to nozzle 32.

Opening 36 may be placed in or adjacent the venturi where the compressed gas is provided under pressure to the upstream end of the venturi, and where it loses pressure as it accelerates through the constriction of venturi 32a. Applicant has found that locating the opening with a 0.08 inch gap (area approximately equal to 0.014 in²) just on or adjacent the downstream edge of the constriction provides sufficient pressure differential to move dust DU from the container through the nozzle and out outlet tube 34 as a dust gas D/G emulsion.

Although the invention has been described in connection with the preferred embodiment, it is not intended to limit the invention's particular form set forth, but on the contrary, it is intended to cover such alterations, modifications, and equivalences that may be included in the spirit and scope of the invention as defined by the appended claims.

1. A device for applying a dust insecticide, the device comprising:
a dust container for containing dust;
a compressed gas cylinder for containing compressed gas;
a wand assembly including a blowgun with a trigger, and a barrel, the wand assembly also including a nozzle having a venturi adapted to mix the dust and compressed gas when the trigger is activated, the barrel engaging the blowgun and the nozzle; and
lines for connecting the gas cylinder to the blowgun and the dust container to the nozzle.

2. The device in claim 1, wherein the nozzle is configured to generate at least a partial vacuum and draw the dust from the container into the nozzle.

3. The device in claim 2, wherein the nozzle includes a gap proximate the venturi.

4. The device in claim 1, wherein the wand assembly further includes an outlet tube engaging the nozzle.

5. The device in claim 1, wherein the dust container and compressed gas cylinder are engaged with one another.

6. The device of claim 1, wherein the dust container and compressed gas cylinder are engaged to a backpack.

7. The device in claim 1, wherein the lines are flexible and between about 4 and about 10 feet in length.

8. The device in claim 1, wherein the dust container line is attached to the wand at or near where the barrel attaches to the blowgun.

9. The device in claim 1, further including a regulator engaged between the compressed gas cylinder and the line to the blowgun for providing regulated gas to the blowgun.

10. The device in claim 2, wherein the dust container and compressed gas cylinder are engaged with one another.

11. The device in claim 2, wherein the lines are flexible and between about 4 feet and about 10 feet in length.

12. The device in claim 2, wherein the dust container line is attached to the wand at or near where the barrel attaches to the blowgun.

13. The device in claim 2, further including a regulator engaged between the compressed gas cylinder and the line to the blowgun for providing regulated gas to the blowgun.

14. The device in claim 3, wherein the dust container and compressed gas cylinder are engaged with one another; wherein the lines are flexible and between about 4 feet and about 10 feet in length; wherein the dust container line is attached to the wand at or near where the barrel attaches to the blowgun; and further including a regulator engaged between the compressed gas cylinder and the line to the blowgun for providing regulated gas to the blowgun.

15. A device for applying a dust insecticide, the device comprising:
a dust container for containing dust;
a compressed gas cylinder for containing compressed gas;
a wand assembly including a blowgun with a trigger, and a barrel, the wand assembly also including a nozzle having a venturi adapted to mix the dust and compressed gas when the trigger is activated, the barrel engaging the blowgun and the nozzle;
lines for connecting the gas cylinder to the blowgun and the dust container to the nozzle;
wherein the nozzle is configured to generate at least a partial vacuum and draw the dust from the container into the nozzle;
wherein the nozzle includes a gap proximate the venture;
wherein the wand assembly further includes an outlet tube engaging the nozzle;
wherein he dust container and compressed gas cylinder are engaged with one another;
wherein the lines are flexible and between about 4 feet and about 10 feet in length;
wherein the dust container line is attached to the wand at or near where the barrel attaches to the blowgun; and
further including a regulator engaged between the compressed gas cylinder and the line to the blowgun for providing regulated gas to the blowgun;
wherein the dust container and compressed gas cylinder are engaged with a backpack.
